(19) United States
(12) Patent Application Publication
(10) Pub. No.: US 2025/0091884 A1
(43) Pub. Date: Mar. 20, 2025

(54) ALUMINOSILICATE AEROGELS

(71) Applicant: Aspen Aerogels, Inc., Northborough, MA (US)

(72) Inventors: Sean Depner, Worcester, MA (US); Owen Evans, Chelmsford, MA (US); lrene Melnikova, Plainville, MA (US); Roxana Trifu, Northborough, MA (US); Wendell Rhine, Belmont, MA (US); George Gould, Mendon, MA (US)

(21) Appl. No.: 18/698,323

(22) PCT Filed: Jun. 9, 2023
(86) PCT No.: PCT/US2023/025006

§ 371 Date: Apr. 3, 2024

Related U.S. Application Data
(60) Provisional application No. 63/351,072, filed on Jun. 10, 2022.

(51) Int. Cl. C01B 33/26; H01M 10/658

(52) U.S. Cl. CPC C01B 33/26; C01P 2002/88; C01P 2004/84; C01P 2006/10; C01P 2006/12; C01P 2006/14; C01P 2006/16; C01P 2006/32; H01M 10/658

(57) ABSTRACT

Methods and compositions herein relate to producing an aluminosilicate aerogel. The method may include receiving a silica precursor in solvent, hydrolyzing the silica precursor to produce colloidal silica, introducing an aluminum compound to the colloidal silica to produce a colloidal aluminosilicate suspension, converting the aluminosilicate suspension to an aluminosilicate gel composition, and forming the aluminosilicate aerogel by extracting fluid.

### CROSS-REFERENCE TO RELATED APPLICATION

This application claims the benefit of priority to U.S. Provisional Patent Application Ser. No. 63/351,072 entitled “HIGH TEMPERATURE AEROGEL MATERIALS COMPRISING ALUMINOSILICATE AEROGELS,” filed Jun. 10, 2022, the disclosure of which is incorporated herein in its entirety by reference.

### TECHNICAL FIELD

The invention relates generally to aerogel technology. The invention relates more particularly, in various examples, to methods for producing aluminosilicate aerogels and aluminosilicate aerogel composites.

### BACKGROUND

Low-density aerogel materials are good solid insulators. Aerogels function as insulators primarily by minimizing conduction due to low structural density results in tortuous path for energy transfer through the solid framework. Heat transfer through aerogels is also limited by reduced convection through large specific pore volumes and very small pore sizes. Radiation may be limited by dispersing infrared (“IR”) absorbing or scattering dopants throughout the aerogel matrix.

Aerogels can be used in a broad range of applications, including, but not limited to: heating and cooling insulation, acoustics insulation, electronic dielectrics, aerospace, energy storage and production, and filtration. Furthermore, aerogel materials display many other interesting acoustic, optical, mechanical, and chemical properties that make them abundantly useful in various insulation and non-insulation applications. Silica based aerogels are one type of commonly used aerogel materials.

### SUMMARY

In some examples, the techniques described herein relate to a method of making an aluminosilicate aerogel, the method including: receiving a silica precursor in solvent; hydrolyzing the silica precursor to produce colloidal silica; introducing an aluminum compound to the colloidal silica to produce a colloidal aluminosilicate suspension; converting the aluminosilicate suspension to an aluminosilicate gel composition; and forming the aluminosilicate aerogel by extracting fluid.

In some examples, the techniques described herein relate to a method of making an aluminosilicate aerogel, the method including: mixing a silica precursor in solvent to produce a precursor mixture; adding a sol initiator to the precursor mixture to produce a colloidal silica; adding an aluminum compound to the colloidal silica to form a colloidal aluminosilicate suspension; adding a gel initiator to the colloidal aluminosilicate suspension to convert the colloidal aluminosilicate suspension to an aluminosilicate gel composition; and extracting fluid from the aluminosilicate gel composition to form the aluminosilicate aerogel.

In some examples, the techniques described herein relate to an aerogel including aluminosilicate comprising an aluminum-containing shell surrounding a silica core, wherein the aerogel comprises a thermal conductivity of about 25 to about 30 mW/m-K.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various examples discussed in the present document.

FIG. 1 depicts the thermal conductivity of an aluminosilicate aerogel in an example.

FIG. 2 depicts thermal conductivity at varying temperatures of an aluminosilicate aerogel in an example.

FIG. 3 depicts the density of an aluminosilicate aerogel in an example.

FIG. 4 depicts the cold face temperatures in flame impingement of an aluminosilicate aerogel in an example.

FIG. 5 depicts surface area, pore size, and pore volume of an aluminosilicate aerogel in an example.

FIG. 6A and FIG. 6B depict surface area of an aluminosilicate aerogel in an example.

FIG. 7A and FIG. 7B depict surface area of an aluminosilicate aerogel in an example.

FIG. 8A and FIG. 8B depict the simulated thermal runaway temperatures of an aluminosilicate aerogel in an example.

FIG. 9 depicts shrinkage effects of the thermal runaway simulation on an aluminosilicate aerogel in an example.

FIG. 10 depicts the effect of thermal runaway on thermal conductivity for an aluminosilicate aerogel in an example.

FIG. 11 depicts the effect of thermal runaway on thickness and density of an aluminosilicate aerogel in an example.

FIG. 12 depicts testing of an aluminosilicate aerogel in an example.

FIG. 13 depicts testing of an aluminosilicate aerogel in an example.

FIG. 14 depicts simulated thermal runaway testing of an aluminosilicate aerogel in an example.

### DETAILED DESCRIPTION

Reference will now be made in detail to certain examples of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

The present disclosure provides compositions for and methods of making a high temperature aerogel material, and specifically a high temperature aluminosilicate aerogel. The proposed methods and materials allow for higher thermal stability and better protection against much higher temperatures and abrasive flame events relative to non-aluminosilicate aerogel thermal barrier materials. The aerogel discussed herein has low thermal conductivity, and excellent acoustic properties. The aerogel discussed herein can be used, for example, in the thermal management of high density lithium metal batteries, where thermal runaways are anticipated to be at high temperatures around 1200° C. This is significantly higher that the failure point of silica (approximately 600° C.), which is a more commonly used aerogel material.

Aerogels are a class of porous materials with open-cells comprising a framework of interconnected structures, with a corresponding network of pores integrated within the framework, and an interstitial phase within the network of pores which is primarily comprised of gases such as air. Aerogels are typically characterized by a low density, a high porosity, a large surface area, and small pore sizes. Aerogels can be distinguished from other porous materials by their physical and structural properties. Many potential applications of aerogels, such as with lithium-ion batteries, include environments where a high temperature resistance is desired.

For example, some aerogel applications require thermal management of temperatures higher than the failure point of silica, above 600° C. In an example, for thermal heat barriers used in battery packs, this is driven by developing battery chemistries with higher energy densities. In the event of a thermal runaway, these higher energy density batteries can produce flame jets and thermal loads higher than 1000° C. Such thermal runaway events can shut down whole battery stacks in particular devices. This creates a need for new material sets capable of handling these temperature profiles, thereby preventing one cell in a battery pack in thermal runaway from damaging other cells in the battery pack that are not in thermal runaway, or causing the other cells to begin thermal runaway.

Thus, a problem to be solved is an improved aerogel response to flame impingement and reduced thermal conductivity, both of which can be beneficial in particular uses of aerogel materials. Specifically, aerogel material compositions that can help reduce thermal runaway, provide physical resistance to the erosion from cell ejecta, and allow for passive thermal protection to interrupt fire events, such as in vehicles, are desired.

In some cases, silica based aerogels are used due to their low density and low thermal conductivity. Silica based aerogels, however, can shrink and densify between 650° C. and 950° C., opening holes for heat to pass through when exposed to high temperatures, such as temperatures encountered during a thermal runaway event of a lithium battery. In other words, silica undergoes rapid thermal expansion and changes in morphology and density at such high temperatures. Moreover, such sintering and densification of silica leads to cracking or fracture. Sintering and/or densification can cause the edges of a silica aerogel thermal barrier to shrink, thereby cracking and, reducing the lifespan of such materials.

To completely shut down a thermal runaway, the thermal barrier needs to prevent heat from reaching neighboring cells. Aluminosilicate aerogels have exceptional flame resistance. Moreover, aluminosilicate aerogel has low thermal conductivity, coupled with inherent endothermic solid-to-solid phase transitions which may act as a heat sink, further preventing the spread of a thermal runaway.

Specifically, aluminosilicate aerogel is a material that can withstand temperatures up to 1300° C. When heating from room temperature to 400° C., there is a phase change similar to that of pure alumina, from γ-AlO(OH) to γ/η-alumina, with mass loss due to dehydration. As the heat is raised to 1100° C., the material is further phase transformed through Θ and δ phases of alumina before arriving at ax-alumina between 1200-1300° C. These endothermic phase transformations absorb heat, which contributes to the effectiveness of aluminosilicate materials in managing heat. These aspects further have the benefit of reducing any physical degradation mechanisms (e.g., via shrinkage, densification, etc.), thereby prolonging the integrity and lifespan of the mesoporous aerogel structure and the thermal barrier in which the aluminosilicate aerogel material is used. In some cases, aluminosilicate aerogels can be amalgam aerogels.

Overall, the low thermal conductivity, the many endothermic solid-to-solid phase transitions, and the ability to maintain physical integrity when exposed to high flame temperatures and abrasive ejecta make aluminosilicate aerogels a superior material for use in high temperature applications.

However, one challenge presented by aluminosilicate aerogel materials has been gelation times longer than those observed in silica aerogel materials. Previously, these long gelation times reduce the efficiency of production and general manufacturability of aluminosilicate materials. For example, prior methods of production spent over an hour to form a wet gel network of aluminosilicate aerogel, compared to the production of conventional silica aerogel of a few minutes. The methods discussed herein significantly reduce the production time of aluminosilicate aerogel to a handful of minutes, similar to that observed for conventional silica aerogel materials, thereby removing one challenge to the wide scale adoption of aluminosilicate materials.

The proposed methods and compositions provide several advantages, some of which are unexpected. The high temperature aerogels discussed herein are much more thermally resistant than other iterations of silica based aerogels. The aerogels discussed herein additionally enable the use of reinforcement materials and methods that may inherently be less thermally durable compared to the aerogel itself because of the added thermal stability provided by the aluminosilicate aerogel itself. These less thermally durable reinforcement materials may not be used in other non-aluminosilicate compositions

Moreover, such aluminosilicate aerogels retain thermal conductivity over long exposures to high temperatures. Aluminosilicate aerogels in particular do not crack at higher temperatures, compared to silica-based aerogels. Because such aluminosilicate aerogels do not crack, and retain continuity, they do not lose thermal conductivity over time, compared to silica-based aerogels. Thus, long term, aluminosilicate aerogels are physically and mechanically more durable (e.g., retain continuity of the porous network without cracking, maintain dimensions and dimensional consistency with +/−10% of ambient temperature values) even when exposed to high temperatures, unlike other material compositions. Generally, aluminosilicate aerogels are resistant to thermally related degradation.

Furthermore, prior aerogel production techniques relied on solution phase chemistry, which was relatively homogenous. By comparison, some of the methods discussed herein use a heterogeneous approach which delays the phase change onset found in uniform aluminosilicate. This allows for improved structural makeup of the aerogel when crystallization occurs, with improved surface area and porosity, while maintaining good thermal properties.

Additionally, the proposed methods of making aluminosilicate aerogels have beneficial shorter production times, and use relatively safer materials. While other techniques for production of aluminosilicate aerogels took well over an hour, the methods discussed herein can be done in minutes, creating better efficiency for manufacturing. The component materials themselves are also safer compared to other precursors, and need only be handled for a shorter period of time, improving overall safety.

Finally, the discussed aluminosilicate aerogels can be easily used with a variety of beneficial reinforcement materials. Specifically, aluminosilicate can be produced with various reinforcement materials such as fiber or foam based reinforcement materials to provide a desired mechanical robustness. Such composite material is buildable and durable. However, even without the use of reinforcement materials, the aluminosilicate aerogel can be relatively resilient and durable, for example in a battery environment, due to its higher thermal capacity.

Discussed herein are example methods of making aluminosilicate aerogel and example aluminosilicate aerogels themselves.

### Methods of Making Aluminosilicate Aerogel

The example methods described herein can produce aerogel materials for high temperature applications. Some of the aluminosilicate aerogel materials described herein can include a silica-shell grown on an alumina core. To produce this aerogel, the combination of an alumina compound (e.g., boehmite) with silica at the desired temporal moment during the production process can create mechanical benefits to the aerogel. At a high level, a silica precursor, such as a silica salt, can be hydrolyzed completely. After which, during a casting step, an alumina compound, such as boehmite, can be added to the hydrolyzed silica precursor. A variety of additives can optionally be added at this time. The aerogel can then be properly aged to develop a continuous, three-dimensional nanoporous network of aluminosilicate strands that define a nanoporous network.

An aluminosilicate aerogel can be formed by combining a silica gel precursor, or silica gel, with an aluminum compound. In an example, the process of forming an aluminosilicate aerogel can include: 1) providing a precursor mixture comprising a silica gel precursor and a solvent; 2) adding a sol initiator to the precursor mixture, wherein, in the presence of the sol initiator, the silica gel precursor is hydrolyzed to form colloidal silica; 3) adding an aluminum compound to the precursor mixture to produce a colloidal aluminosilicate suspension, and optionally casting the materials onto a reinforcement material; 4) adding a gel initiator to the colloidal-silica suspension, wherein, in the presence of the gel initiator the colloidal aluminosilicate suspension is converted into an aluminosilicate gel composition; and 5) extracting fluid from the aluminosilicate gel composition to form the aluminosilicate aerogel composition.

A variety of approaches for production of aluminosilicate aerogel can be used: a core/shell method, a combination sol method, or an additive method. In the first method (core/shell), the aluminum containing compound can be added during hydrolysis of the silica precursor, coinciding with the exothermic peak of the hydrolysis reaction. In the second method (combination sol), the aluminum containing compound can be added at the end of hydrolysis. In the third method, the aluminum containing compound can be added during casting the aerogel onto a reinforcement material.

These processes are discussed below in greater detail. However, the specific examples and illustrations provided herein are not intended to limit the present disclosure to any specific type of aerogel and/or method of preparation. The present disclosure can include any aerogel formed by any associated method of preparation known to those in the art.

### Detailed Example Aspects

Silica Precursor. A silica precursor is provided, received, or prepared. In some cases, the silica precursor can be prepared in advanced, and simply received by the operator preparing the aluminosilicate aerogel. For example, a precursor mixture can be received in solvent. Such a mixture can include both the silica precursor compound itself and one or more appropriate solvents.

Silica gel precursor materials for silica based aerogel synthesis include, but are not limited to: metal silicates such as sodium silicate or potassium silicate; alkoxysilanes such as tetraethoxysilane (TEOS), tetramethoxysilane (TMOS), and tetra-n-propoxysilane; partially hydrolyzed alkoxysilanes such as partially hydrolyzed TEOS and partially hydrolyzed TMOS; condensed polymers of alkoxysilanes such as condensed polymers of TEOS and condensed polymers of TMOS; alkylalkoxy silanes, and combinations thereof.

Specific examples of silica gel precursors include, but are not limited to, triethyl orthosilicate (TEOS), trimethyl orthosilicate (TMOS), methyl trimethoxysilane (MTMS), methyl triethoxysilane (MTES), dimethyl diethoxysilane (DMDES), trimethyl methoxysilane (TMS), dimethyl dimethoxysilane (DMS), trimethyl ethoxysilane, ethyl triethoxysilane (ETES), diethyl diethoxysilane, propyl trimethoxysilane, propyl triethoxysilane, phenyl trimethoxysilane, phenyl triethoxysilane (PhTES), hexamethyldisilazane and hexaethyldisilazane.

In certain examples of the present disclosure, pre-hydrolyzed TEOS, such as Silbond H-5 (SBH5, Silbond Corp), which is hydrolyzed with a water/silica ratio of about 1.5-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

In an example, the first step in forming an aluminosilicate aerogel composition is generally the formation of a silica gel precursor solution through hydrolysis and condensation of silicon alkoxide precursors in an alcohol-based solvent. Major variables in the formation of silica based aerogels include the type of silicon alkoxide precursors included in the precursor solution, the nature of the solvent, the processing temperature and pH of the precursor solution (which may be altered by addition of an acid or a base), and precursor/solvent/water ratio within the precursor solution. Control of these variables in forming a precursor solution can permit control of the growth and aggregation of the gel framework during the subsequent transition of the gel material from the “sol” state to the “gel” state. While properties of the resulting aerogels are affected by the pH of the precursor solution and the molar ratio of the reactants, any pH and any molar ratios that permit the formation of gels may be used in the present disclosure.

A precursor mixture is formed by combining at least one silica gel precursor with a solvent. Suitable solvents for use in forming a precursor mixture include lower alcohols with 1 to 6 carbon atoms, preferably 2 to 4, although other solvents can be used as known to those with skill in the art. Examples of useful solvents include, but are not limited to: methanol, ethanol, isopropanol, ethyl acetate, ethyl acetoacetate, acetone, dichloromethane, tetrahydrofuran, and the like. Multiple solvents can also be combined to achieve a desired level of dispersion or to optimize properties of the gel material. Selection of optimal solvents for the sol-gel and gel formation steps thus depends on the specific precursors, fillers and additives being incorporated into the sol-gel solution; as well as the target processing conditions for gelling and liquid phase extraction, and the desired properties of the final aerogel materials.

For the silica precursor, the solvent to silica ratio can be varied to control molecular weight of the mixture and silica percent solids. When hydrolyzed in the next step, the ratio of solvent to silica can also be manipulated to adjust the acid content in the mixture.

Hydrolysis. The silica precursor is hydrolyzed to form colloidal silica. In an example, this can include adding a sol initiator to the precursor mixture. The sol initiator can be, for example, hydrochloric acid, sulfuric acid, phosphoric acid, nitric acid, oxalic acid, acetic acid, or combinations thereof. The sol initiator can be added prior to introducing an aluminum compound. In an example, the silica precursor can be fully hydrolyzed prior to introduction of an aluminum compound.

In an example, water can be present in the precursor solution. The water acts to hydrolyze the metal alkoxide precursors into metal hydroxide precursors. The hydrolysis reaction can be (using TEOS in ethanol solvent as an example).

Si(OC₂H₅)₄+4H₂O→Si(OH)₄+4(C₂H₅OH) (1)

The resulting hydrolyzed metal hydroxide precursors remain suspended in the precursor solution in a “sol” state, either as individual molecules or as small polymerized (or oligomarized) colloidal clusters of molecules. For example, polymerization/condensation of the Si(OH)4 precursors can occur as follows:

2Si(OH)₄—*(OH)₃Si—O—Si(OH)₃+H₂O (2)

This polymerization can continue until colloidal clusters of polymerized (or oligomarized) SiO₂ (silica) molecules are formed. The ratio of the silica gel precursor to water is in a range from about 1.0 to about 2.5. In one aspect, the ratio of silica gel precursor to water is about 1.8. In one aspect, the silica gel precursor is partially hydrolyzed. The extent of hydrolysis can be measured by the solids content of the partially hydrolyzed silica gel precursor. In some aspects, the solids content of the partially hydrolyzed silica gel precursor is about 10% to about 30% silicon dioxide.

Acids and bases can be added to precursor mixture to control the pH of the precursor mixture. Acids or bases can be used as a sol initiator. The sol initiator catalyzes the hydrolysis and condensation reactions of the silica gel precursor materials, allowing the silica gel precursor materials to be converted into colloidal silica suspended in the solvent. In an example, the sol initiator is an acid. While any acid may be used to as a sol initiator, and to obtain a lower pH precursor mixture, preferable acids include: HCl, H2S04, H3PQ4, nitric acid, oxalic acid and acetic acid.

Adding the Aluminum Compound. After hydrolysis, the aluminum compound can be added to the precursor mixture to produce a colloidal aluminosilicate suspension. The timing of addition of the aluminum compound can affect the final structure of the aluminosilicate aerogel. For example, silica growth, and formation of a silica network, can occur separately from alumina growth and formation of an alumina network. Where the silica is hydrolyzed first, the silica network can grow first, and trap the aluminum compound therein. This can allow for formation of a mechanically beneficial core/shell structure. Such an aluminum compound can include boehmite, pseudoboehmite, alumina, aluminum trihydroxide, aluminum-alkoxides, aluminum hydro-carboxylic acid species, or combinations thereof.

For example, after hydrolysis of the silica gel precursor, an aluminum compound is added to the mixture. Examples of aluminum compounds that can be added to the precursor mixture include, but are not limited to, boehmite, pseudoboehmite, alumina, aluminum trihydroxide, aluminum-alkoxides and aluminum hydro-carboxylic acid species. Addition of an aluminum compound during hydrolysis of the silica gel precursor, or after conversion of the silica gel precursor to a colloidal silica suspension, creates a colloidal aluminosilicate suspension.

Aluminum compounds are amphoteric compounds, i.e., compounds that react with both bases and acids. When an acid or base is used as the sol initiator to catalyze the hydrolysis of the silica gel precursor, the initiator may react with any aluminum compounds present in the mixture. Aluminum compounds react with acids or bases to rapidly gel, preventing the aluminum compound from being incorporated into the silica framework in a manner that would improve the heat resistance properties of the resulting aerogel. To avoid gelation of the aluminum compounds, the aluminum compounds are added to the precursor mixture after hydrolysis of the silica gel precursor is initiated to produce a colloidal aluminosilicate suspension.

In one example, the aluminum compound is added to the precursor mixture about (+/−10%) 1 minute to about 1 hour after the sol initiator (e.g., an acid) is combined with the silica gel precursor. Without being bound to any theory, it is believed that the delayed addition of the aluminum compound avoids unwanted reaction of the aluminum compound with the sol initiator (e.g., an acid and water). It is also believed that by adding the aluminum compound after the hydrolysis is initiated, the aluminum compounds become coated with the partially hydrolyzed silica gel precursor, forming a shell/core composite with the aluminum compound as the core and the hydrolyzed silica gel precursor as the shell. The shell of hydrolyzed silica gel precursor protects the aluminum compound core from reacting with the gel initiator (typically a base) in the subsequent gelation reaction.

In another example, the aluminum compound is added to the precursor mixture about 1 hours to about 24 hours after the sol initiator (e.g., an acid) is combined with the silica gel precursor. In this example, the aluminum compound is added to the precursor mixture after substantial hydrolysis of the silica gel precursors is nearly complete. Without being bound to any theory, it is believed that the addition of the aluminum compound at the end of the hydrolysis reactions avoids unwanted reaction of the aluminum compound with the sol initiator (e.g., an acid). It is also believed that by adding the aluminum compound after the hydrolysis is complete, or nearly complete, the aluminum compounds will bind together with silica precursors of appropriate molecular weight, changing the surface of the aluminum compound enough for the aluminum compound to survive the subsequent exposure to the gel initiator (e.g., a base). To promote binding of the aluminum compound to the hydrolyzed silica gel precursors, the mixture may be stirred or agitated.

Hydrolysis time can be varied to change molecular weight. Temperature of hydrolysis can be controlled to vary molecular weight.

Gelation. The colloidal suspension can be converted to an aluminosilicate gel composition, such as through the addition of a gel initiator, such as a metal hydroxide base or an amine base.

In an example, after addition of the aluminum compound is complete, and the hydrolysis reaction is substantially finished, the resulting colloidal aluminosilicate suspension is converted into an aluminosilicate gel composition by adding a gel initiator to the suspension. The gel initiator can be an acid or a base that catalyzes the gelation reaction of the silica. Typically, the gel initiator is a base. Any base may be used as the gel initiator. In an example, metal hydroxide bases can be used to catalyze the gelation reaction. Exemplary metal hydroxide bases include, but are not limited to, sodium hydroxide, lithium hydroxide, calcium hydroxide, potassium hydroxide, strontium hydroxide, and barium hydroxide. In another example of the present disclosure, amine bases can be used to be used as the gel initiator. Exemplary amine bases include, but are not limited to, tetraalkylammonium hydroxides, choline hydroxide, trialkylamines, amidines, guanidines and imidazoles. Specific examples of amine bases include tetramethylammonium hydroxide, tetrabutylammonium hydroxide, guanidine, 1,8-Diazabicyclo[5.4.0]undec-7-ene (DBU), 1,4-diazabicyclo[2.2.2]octane (DABCO), pyridine, imidazole, and 4,5-dihydroimidazole.

The resulting aluminosilicate gel composition can include additional co-gelling precursors, as well as filler materials and other additives. Filler materials and other additives may be dispensed in the precursor solutions, or in any of the intermediate mixtures, at any point before or during the formation of a gel. Filler materials and other additives may also be incorporated into the gel material after gelation through various techniques known to those in the art. Preferably, the precursor solution comprising the silica gel precursors, aluminum compounds, solvents, catalysts, water, filler materials and other additives is a homogenous solution which is capable of effective gel formation under suitable conditions. The process of transitioning the colloidal aluminosilicate suspension into an aluminosilicate gel comprises an initial gel formation step wherein the gel solidifies up to the gel point of the gel material. The gel point of a gel material may be viewed as the point where the gelling solution exhibits resistance to flow and/or forms a substantially continuous polymeric framework throughout its volume. A range of gel-forming techniques are known to those in the art. Examples include, but are not limited to: maintaining the mixture in a quiescent state for a sufficient period of time; adjusting the pH of the solution; adjusting the temperature of the solution; directing a form of energy onto the mixture (ultraviolet, visible, infrared, microwave, ultrasound, particle radiation, electromagnetic); or a combination thereof.

Reinforcement Materials. In some cases, the aluminosilicate aerogel can be made directly onto one or more reinforcement materials. In some aspects, this can be accomplished by dispersing the colloidal aluminosilicate suspension on a reinforcement material prior to converting the aluminosilicate suspension to an aluminosilicate gel composition. In some aspects, this can be accomplished by dispersing the colloidal silica on a reinforcement material and contemporaneously introducing the aluminum compound. Such a reinforcement material can be, for example, a fiber material or a foam material.

For instance, gel materials of the present disclosure can be produced through a continuous casting and gelation process. In a continuous casting process, a continuous sheet of fibrous material or a foam material can be used as a support during a continuous casting process. The fibrous support can improve the flexibility and/or strength of the aerogel material. In an example of the present disclosure a fiber supported wet gel material is formed by adding a gel precursor composition, typically a colloidal composition, to a fiber reinforcing material and forming a wet gel from the gel precursor composition when disposed on the fiber reinforcement material. In this method, the wet gel material formed from the gel precursor composition is integrated to the fiber reinforcement material.

In some aspects, an aluminosilicate wet gel material can be formed in a casting process, preferably in a continuous casting process. In the method, a precursor mixture is obtained that includes a silica gel precursor and a solvent. A sol-initiator is added to the silica gel precursor mixture to initiate hydrolysis of the silica gel precursor, as had been described above. When hydrolysis of the silica gel precursor is substantially completed, the resulting colloidal silica is dispersed onto a fiber reinforcement material. Before, during, or after the colloidal silica is dispersed onto the fiber reinforcement material, an aluminum compound is mixed with the colloidal silica to form an aluminum compound containing colloidal silica suspension.

In some aspects, the aluminum compound can be combined with the colloidal silica in a step preceding the dispersion of the colloidal silica onto the fiber reinforcement material. In another example, the casting device is loaded with colloidal silica and an aluminum compound. The casting device applies the colloidal silica and the aluminum compound substantially simultaneously to the fiber reinforcement material. In this example, the colloidal silica and the aluminum compound may be mixed in the casting device and the colloidal silica-aluminum compound mixture applied to the fiber reinforcement material.

In some aspects, the casting device sequentially applies the colloidal silica and the aluminum compound to the fiber reinforcement material. In this example, the casting device may first apply the colloidal silica to the fiber reinforcement material. After the application of the colloidal silica is performed, application of the aluminum compound is performed. In an alternate example of this example, the order can be reversed. In the reversed method the aluminum compound is first applied to the fiber reinforcement material, followed by the application of the colloidal silica.

Here, a gel initiator is added to the aluminum compound containing colloidal-silica suspension that is disposed on the fiber reinforcement material. The gel initiator catalyzes conversion of the aluminum compound containing colloidal silica suspension into an aluminosilicate gel composition.

In some aspects, an aluminosilicate wet gel material can be formed in a casting process, preferably in a continuous casting process. In this alternate method, a precursor mixture is obtained that includes a silica gel precursor and a solvent. A sol-initiator is added to the silica gel precursor mixture to initiate hydrolysis of the silica gel precursor, as had been described above. An aluminum compound is added to the precursor mixture before the hydrolysis is complete, as was previously described. The aluminum compound can be added near the beginning of the hydrolysis, or near the completion of the hydrolysis. When hydrolysis of the aluminum compound/silica gel precursor is substantially completed, the resulting colloidal aluminosilicate is dispersed onto a fiber reinforcement material. A gel initiator is added to the colloidal alumina/silica suspension that is disposed on the fiber reinforcement material. The gel initiator catalyzes conversion of the aluminum compound containing colloidal silica suspension into an aluminosilicate gel composition.

In some aspects of large scale production of an aerogel, the fiber reinforcement material is in the form of a continuous sheet of interconnected or interlaced fiber reinforcement materials. The precursor solution is incorporated into a continuous sheet of interconnected or interlaced fiber reinforcement materials. The initial wet gel material is produced as a continuous sheet of fiber reinforced gel by casting or impregnating a gel precursor solution into a continuous sheet of an interconnected or an interlaced fiber reinforcement material. This technique may be applied to discrete sheets of fiber (or foam) reinforcement material with equivalent effectiveness. As will be described in more detail, the liquid phase may then be at least partially extracted from the fiber-reinforced wet gel material to produce a sheet-like, fiber reinforced aerogel composite.

Aerogel composites may be fiber-reinforced with various fiber reinforcement materials to achieve a more flexible, resilient and conformable composite product. Fiber reinforcement materials may be in the form of discrete fibers, woven materials, non-woven materials, battings, webs, mats, Skrims, and felts. Fiber reinforcements can be made from organic fibrous materials, inorganic fibrous materials, or combinations thereof. Fiber reinforcement materials can comprise a range of materials, including, but not limited to: polyesters, polyokfin terephthalates, poly(ethylene) naphthalate, polycarbonates (examples Rayon, Nylon), cotton, (e.g. lycra manufactured by DuPont), carbon (e.g. graphite), polyacrylonitliles (PAN), oxidized PAN, uncarbonized heat treated PANs (such as those manufactured by SGL carbon), fiberglass based material (like S-glass, 901 glass, 902 glass, 475 glass, E-glass,) silica based fibers like quartz, (e.g. Quartzel manufactured by Saint-Gobain), Q-felt (manufactured by Johns Manville), Saffil (manufactured by Saffil), Durablanket (manufactured by Unifrax) and other silica fibers, Duraback (manufactured by Carborundum), Polyaramid fibers like Kevlar, Nornex, Sontera (all manufactured by DuPont), Conex (manufactured by Taijin), polyolefins like Tyvek (manufactured by DuPonl), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by \V.L. GORE), silicon carbide fibers like Nicalon (manufactured by COI Ceramics), ceramic fibers like Nextel (manufactured by 3M), acrylic polymers, wool fibers, silk, hemp, leather, suede, PBO-Zylon fibers (manufactured by Tyobo), liquid crystal material like Vectan (manufactured by Hoechst), cambrelle fiber (manufactured by DuPont), polyurethanes, polyamides, metal fibers such as boron, aluminum, iron, and stainless steel fibers, and thermoplastics like PEEK, PES, PEI, PEK, PPS. The aerogel can be reinforced on a foam material. The foam is an interconnected series of struts, forming open cell and closed cell structures. The foam can be inorganic (Alumina, silicon carbide, etc) or organic (melamine, polyurethane, PEI, Carbon, etc) or a metal foam. Aerogel composites of the present disclosure can have a thickness of 15 mm or less, 10 mm or less, 5 mm or less, 3 mm or less, 2 mm or less, or 1 mm or less.

Extraction of Fluid. After gelation, the aluminosilicate aerogel can be formed through extraction of excess fluid, such as through a supercritical extraction process.

In an example of the present disclosure, the aerogel composite may include an opacifying additive to reduce the radiative component of heat transfer. At any point prior to gel formation, opacifying compounds or precursors thereof may be dispersed into the mixture comprising gel-forming material. Exemplary opacifying additives include, but are not limited to, B4C, Diatomite, Manganese ferrite, MnO, NiO, SnO, indium tin oxide, Ag20, Bh03, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof. Opacifying additives may be added at any stage of the process of forming the aerogel. Preferably, addition of opacifying additives is performed at the colloidal silica stage, colloidal aluminosilicate stage, or is added to the aluminosilicate wet gel material.

The process of transitioning gel-forming components into a gel material can also include an aging step (also referred to as curing) prior to liquid phase extraction. Aging a gel material after it reaches its gel point can further strengthen the gel framework by increasing the number of cross-linkages within the network. The duration of gel aging can be adjusted to control various properties within the resulting aerogel material. This aging procedure can be useful in preventing potential volume loss and shrinkage during liquid phase extraction. Aging can involve: maintaining the gel (prior to extraction) at a quiescent state for an extended period; maintaining the gel at elevated temperatures; adding cross-linkage promoting compounds; or any combination thereof.

Aging. In some cases, the aluminosilicate gel composition can be aged prior to forming the aluminosilicate aerogel. For example, aging the aluminosilicate gel composition can include heating the aluminosilicate gel composition at a temperature between 60° C. and 120° C. For example, aging the aluminosilicate gel composition can be done for a time ranging from about 1 hour to about 24 hours.

The time period for transitioning gel-forming materials into a gel material includes both the duration of the initial gel formation (from initiation of gelation up to the gel point), as well as the duration of any subsequent curing and aging of the gel material prior to liquid phase extraction (from the gel point up to the initiation of liquid phase extraction). The total time period for transitioning gel-forming materials into a wet-gel material is typically between about 1 minute and several days, preferably about 30 hours or less, about 24 hours or less, about 15 hours or less, about 10 hours or less, about 6 hours or less, about 4 hours or less, about 2 hours or less, about 1 hour or less, about 30 minutes or less, or about 15 minutes or less. Ideally, the total time period is minimized to allow efficient production of an aerogel.

Aging of the wet gel material can be accomplished by heating the wet gel material for a time sufficient to complete the aging process. In a typical aging process, a wet gel material is placed into an aging vessel. The wet gel material is then heated to an aging temperature and maintained at the aging temperature until the aging process is complete. Optionally, the wet gel material can be washed with an aging fluid prior to, and during, heating. The aging fluid can be used to replace the primary reaction solvent present in the wet-gel. Exemplary aging fluids are water, C1-C6 alcohols, cyclic alcohols, alicyclic alcohols, aromatic alcohols, polyhydric alcohols, ethers, ketones, cyclic ethers, or any combination thereof. Preferred aging fluids include water, methanol, and ethanol. During aging, aging fluid can be substantially continuously passed over and/or through the wet gel material and through the aging vessel. The aging fluid passing through the aging vessel and the wet gel can be fresh aging fluid, or recycled aging fluid.

Once a gel material has been formed and aged, the liquid phase of the gel can then be at least partially extracted from the aluminosilicate wet-gel using extraction methods to form an aerogel material. Liquid phase extraction, among other factors, plays a role in engineering the characteristics of aerogels, such as porosity and density, as well as related properties such as thermal conductivity. Generally, aerogels are obtained when a liquid phase is extracted from a gel in a manner that causes low shrinkage to the porous network and framework of the wet gel.

Aerogel Formation. Aerogels are commonly formed by removing the liquid mobile phase from the gel material at a temperature and pressure near or above the critical point of the liquid mobile phase.

Once the critical point is reached (near critical) or surpassed (supercritical) (i.e., pressure and temperature of the system is at or higher than the critical pressure and critical temperature respectively) a new supercritical phase appears in the fluid that is distinct from the liquid or vapor phase. The solvent can then be removed without introducing a liquid-vapor interface, capillary pressure, or any associated mass transfer limitations typically associated with liquid-vapor boundaries. Additionally, the supercritical phase is more miscible with organic solvents in general, thus having the capacity for better extraction. Co-solvents and solvent exchanges are also commonly used to optimize the supercritical fluid drying process.

One example of extracting a liquid phase from the wet-gel uses supercritical conditions of carbon dioxide, including, for example: first substantially exchanging the primary solvent present in the pore network of the gel with liquid carbon dioxide; and then heating the wet gel beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel.

Finally, the temperature and pressure are slowly returned to ambient conditions to produce a dry aerogel material. Carbon dioxide can also be pre-processed into a supercritical state prior to being injected into an extraction chamber. Further details describing the synthesis of aerogels from wet gel materials can be found in U.S. Patent Application Publication No. 2016/0096949 to Evans et al. and U.S. Patent Application Publication No. 2021/03095227 to Evans et al., both of which are incorporated herein by reference.

### Aluminosilicate Aerogel

The method discussed herein can be used to produce a beneficial aluminosilicate aerogel material. Such an aerogel can include aluminosilicate. The aerogel can be a core shell material, where a silica network is around an alumina network, such as may be seen in cross-section.

The aluminosilicate aerogels discussion herein can have a thermal conductivity of about 20.0 to about 30.0 mW/m-K, of about 21.0 to about 29.0, of about 22.0 to about 28.0, of about 23.0 to about 27.0, of about 24.0 to about 26.0, or of about 25.0 mW/m-K.

The aluminosilicate aerogels discussion herein can have a surface area of at least about 60.0 m²/g. In an example, the aluminosilicate aerogels discussion herein can have a surface area greater than at least about 55.0, 60.0, 65.0, 70.0, 75.0, 80.0, 85.0, 90.0, 95.0, 100.0, 105.0, or 110.0 m²/g.

The aluminosilicate aerogels discussion herein can have an average pore size of about 60 to about 70 Å, of about 61 to about 69, of about 62 to about 68, of about 63 to about 67, of about 64 to about 66, or of about 65 Å.

The aluminosilicate aerogels discussion herein can have a pore volume of about 0.10 to about 0.17 cm³/g, of about 0.11 to about 0.16, of about 0.12 to about 0.15, or of about 0.13 to about 0.14 cm³/g.

The aluminosilicate aerogels discussion herein can have a density of about 0.200 to about 0.300 g/cc, of about 0.210 to about 0.290, of about 0.220 to about 0.280, of about 0.230 to about 0.270, of about 0.240 to about 0.260, or of about 0.250 g/cc.

Aerogel composites of the present disclosure can have a thickness of 15 mm or less, 10 mm or less, 5 mm or less, 3 mm or less, 2 mm or less, or 1 mm or less.

Battery Modules with Aluminosilicate Aerogel

The aluminosilicate aerogels discussed herein can be used for a variety of thermal insulation applications, for example, in use with thermal management of batteries. In one example use, an aluminosilicate aerogel composite may be used as a thermal barrier between individual, or groups of, battery cells. Battery cells are susceptible to catastrophic failure under “abuse conditions.” Abuse conditions include mechanical abuse, electrical abuse, and thermal abuse. One or all of these abuse conditions can be initiated externally or internally. For example, service induced stress, aging, errors in design e.g. configurational parameters such as cell spacing, cell interconnecting style, cell form factor, manufacturing, operation, and maintenance are internal mechanical factors that can cause various kinds of abuse. External mechanical factors include damage or injury to a LIB, such as from a fall or from a penetration of the cell. Electrical abuse conditions mainly include internal or external short-circuiting of a battery cell, overcharge, and over discharge. Thermal abuse is typically triggered by overheating. For example, overheating in a battery cell may be caused by operating the battery cell under high ambient temperatures. Internally, thermal abuse may be caused by electrical and mechanical defects in the battery cells.

In the event of a thermal runaway, these higher energy densities can produce flame jets and thermal loads higher than 1000° C. This creates a need for new materials capable of handling these temperature profiles. An aluminosilicate aerogel composite, which has maximum use temperatures around 1200-1300° C. was found to be useful at preventing high temperature runaway events in energy storage system. When heating from room temperature to 400° C., there is a phase change following the behavior of pure alumina, from γ-AlO(OH) to γ/η-alumina, accompanied by a mass loss and dehydration. As the heat is raised to 1100° C., the aluminosilicate composite passes through the Θ and δ phases of alumina where it ends at a-alumina between 1200-1300° C. These phase transformations help with heat management, and do not destroy the mesoporous aerogel structure.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

### Definitions

The term “about” as used herein can allow for a degree of variability in a value or range, for example, within 10%, within 5%, or within 1% of a stated value or of a stated limit of a range, and includes the exact stated value or range.

The term “aerogel” or “aerogel material” as used herein refers to a gel comprising a framework of interconnected structures, with a corresponding network of interconnected pores integrated within the framework, and containing gases such as air as a dispersed interstitial medium. Aerogel materials are characterized by the following physical and structural properties (according to Nitrogen Porosimetry Testing): (a) an average pore diameter ranging from about 2 nm to about 100 nm, (b) a porosity of at least 80% or more, and (c) a surface area of about 20 m²/g or more. Aerogels or aerogel materials include any aerogels, aerogel materials, or other open-celled compounds which satisfy these defining elements including compounds which can be otherwise categorized as xerogels, cryogels, ambigels, microporous materials, and the like. Aerogel materials may also be further characterized by additional physical properties, including: (d) a pore volume of about 2.0 mL/g or more, preferably about 3.0 mL/g or more; (e) a density of about 0.50 g/cc or less, preferably about 0.25 g/cc or less; and (f) at least 50% of the total pore volume comprising pores having a pore diameter of between 2 and 50 nm; though satisfaction of these additional properties is not required for the characterization of a compound as an aerogel material. An aerogel framework can be made from a range of precursor materials, including: inorganic precursor materials (such as precursors used in producing silica-based aerogels); organic precursor materials (such precursors used in producing carbon-based aerogels); hybrid inorganic/organic precursor materials; and combinations thereof.

Within the context of the present disclosure, the term “amalgam aerogel” refers to an aerogel produced from a combination of two or more different gel precursors.

Within the context of the present disclosure, the term “mesoporous aerogel structure” refers to an aerogel having a three dimensional interconnected network defining a network of pores.

Within the context of the present disclosure, the terms “framework” or “framework structure” refer to the network of interconnected oligomers, polymers or colloidal particles that form the solid structure of a gel or an aerogel. The polymers or particles that make up the framework structures typically have a diameter of about 100 angstroms. However, framework structures of the present disclosure can also include networks of interconnected oligomers, polymers or colloidal particles of all diameter sizes that form the solid structure within in a gel or aerogel.

The term “air” as used herein refers to a mixture of gases with a composition approximately identical to the native composition of gases taken from the atmosphere, generally at ground level. In some examples, air is taken from the ambient surroundings. Air has a composition that includes approximately 78% nitrogen, 21% oxygen, 1% argon, and 0.04% carbon dioxide, as well as small amounts of other gases.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “alkyl” as used herein refers to straight chain and branched alkyl groups and cycloalkyl groups having from 1 to 40 carbon atoms, 1 to about 20 carbon atoms, 1 to 12 carbons or, in some examples, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some examples, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “oligomer” as used herein refers to a molecule having an intermediate relative molecular mass, the structure of which essentially includes a small plurality of units derived, actually or conceptually, from molecules of lower relative molecular mass. A molecule having an intermediate relative mass can be a molecule that has properties that vary with the removal of one or a few of the units. The variation in the properties that results from the removal of the one of more units can be a significant variation.

The term “organic group” as used herein refers to any carbon-containing functional group. Examples can include an oxygen-containing group such as an alkoxy group, aryloxy group, aralkyloxy group, oxo (carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀) hydrocarbyl, wherein R can be hydrogen (in examples that include other carbon atoms) or a carbon-based moiety, and wherein the carbon-based moiety can be substituted or unsubstituted.

The term “polymer” as used herein refers to a molecule having at least one repeating unit and can include copolymers. The polymers described herein can terminate in any suitable way. In some examples, the polymers can terminate with an end group that is independently chosen from a suitable polymerization initiator, —H, —OH, a substituted or unsubstituted (C1-C20)hydrocarbyl (e.g., (C1-C10)alkyl or (C6-C20)aryl) interrupted with 0, 1, 2, or 3 groups independently selected from —O—, substituted or unsubstituted —NH—, and —S—, a poly (substituted or unsubstituted (C1-C20)hydrocarbyloxy), and a poly (substituted or unsubstituted (C1-C20)hydrocarbylamino).

The term “pore” as used herein refers to a depression, slit, or hole of any size or shape in a solid object. A pore can run all the way through an object or partially through the object. A pore can intersect other pores.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “resin” as used herein refers to polysiloxane material of any viscosity including a molecule that includes at least one siloxane monomer that is bonded via a Si—O—Si bond to three or four other siloxane monomers. In one example, the polysiloxane material includes T or Q units, as defined herein.

The term “room temperature” as used herein refers to a temperature of about 15° C. to 28° C.

The term “silica” as used herein refers to silicon dioxide (SiO₂) of any particle size, shape, particle size distribution, shape distribution and surface functionality, including chemically treated silicas. It can also refer to a polysiloxane that includes a silicon and oxygen atom network, including at least in part a silicon-oxygen-silicon (silicon atom bonded to oxygen atom bonded to silicon atom) network, wherein the compound can be a polymer of any length or degree of branching. In various examples, the network can terminate with a Si═O group, or an Si—OH group. The silica gel or matrix can include polysiloxanes in 30%, 50%, 80%, 90%, 95%, 99%, 99.5%, 99.9%, or in any suitable percent composition (wt %).

The term “silicate” as used herein refers to any silicon-containing compound wherein the silicon atom has four bonds to oxygen, wherein at least one of the oxygen atoms bound to the silicon atom is ionic, such as any salt of a silicic acid. The counterion to the oxygen ion can be any other suitable ion or ions. An oxygen atom can be substituted with other silicon atoms, allowing for a polymer structure. One or more oxygen atoms can be double-bonded to the silicon atom; therefore, a silicate molecule can include a silicon atom with 2, 3, or 4 oxygen atoms. Examples of silicates include aluminum silicate. Zeolites are one example of materials that can include aluminum silicate. A silicate can be in the form of a salt or ion.

The term “solvent” as used herein refers to a liquid that can dissolve a solid, liquid, or gas. Non-limiting examples of solvents are silicones, organic compounds, water, alcohols, ionic liquids, and supercritical fluids.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo (carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀) hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “thermoplastic polymer” or “thermoplastic” as used herein refers to a polymer that has the property of converting to a fluid (flowable) state when heated and of becoming rigid (nonflowable) when cooled. The term “thermoplastic polymer in a fluid state” as used herein refers to the polymer being in a molten state or dissolved in an organic solvent.

The term “molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

### EXAMPLES

Various examples of the present disclosure can be better understood by reference to the following Examples which are offered by way of illustration. The present disclosure is not limited to the Examples given herein.

### Example 1. Sample Aluminosilicate Aerogels

Two sets of sample aluminosilicate aerogels were produced according to methods discussed herein, and were tested alongside a comparative sample, all of which are summarized below in Table 1:

TABLE 1
Samples and Comparative Samples

| Sample ID | Description | Production Method |
|---|---|---|
| Sample 1 | Aluminosilicate aerogel | Core/Shell |
| Sample 2 | Aluminosilicate aerogel | Combination Sol |
| Comparative Sample | PyroThin ® ATB1000 | Commercial product |
| | | from Aspen Aerogel |

Both Sample 1 and Sample 2 were prepared with methods similar to those described above. Sample 1 was particularly prepared with a core/shell method, while Sample 2 was prepared with a combination sol method. Both Sample 1 and Sample 2 were tested on 1 mm glass reinforcement material. Both Sample 1 and Sample 2 were produced in 2 mm layers on the reinforcement material unless otherwise noted.

Core Shell Sample Production. Sample 1, an aluminosilicate aerogel, was produced by a core/shell method. Here, the silica precursor was prepared with Tetraethyl orthosilicate (TEOS) from Dow Chemical. Sulfuric acid was used in the sol preparation to hydrolyze the silica precursor. Specifically, the TEOS sol was prepared with a water to TEOS ratio of 1.8, acid content of 5 mM and solid content of 20% silica. Once the sol has been mixed, the solution was initially turbid. At this time, the water and TEOS/Ethanol phases were not soluble. The acid hydrolyzed the TEOS, released more ethanol. At this point, the water was miscible with the rest of the solution. This coincides with the peak exotherm of the reaction.

At this point, the aluminum compound, boehmite (Sasol), was added at an Al:Si ratio of 3:1. If added too early, the boehmite would react with the acidic water and gel immediately. Next, the solution was allowed to stir. A gelling agent, guanidine, was added. The solution was aged between 68 to 120° C. for 1 to 24 hours, and then extracted with supercritical CO₂.

Combination Sol Sample Production. Sample 2, an aluminosilicate aerogel, was produced by a combination sol method. Here, the silica precursor was prepared with Tetraethyl orthosilicate (TEOS). The acid was used in the sol preparation to hydrolyze the silica precursor. Specifically, the TEOS sol was prepared with a water to TEOS ratio of 1.8, acid content of 5 mM and solid content of 20% silica. Once the sol has been mixed, the solution was initially turbid. At this time, the water and TEOS/Ethanol phases were not soluble. The acid hydrolyzed the TEOS, released more ethanol. At this point, the water was miscible with the rest of the solution. This coincides with the peak exotherm of the reaction.

Here, the aluminum compound, boehmite, was added at the end of hydrolysis. This allowed the molecular weight of the TEOS to build, and form a stronger aerogel network between boehmite particles. After TEOS and Boehmite were combined, the sol was stirred to allow the TEOS and Boehmite to bind together, changing the boehmite surface just enough to survive the pH switch and prevent gelling. Subsequently, as described with reference to the core/shell method, a gelling agent, guanidine, was added. The solution was aged, and then extracted with supercritical CO₂.

Comparative Sample. The Comparative Sample (ATB1000) was commercially available aerogel from Aspen Aerogel.

Sample 1, Sample 2, and the Comparative Samples were tested for a variety of properties, such as thermal conductivity, density, flame impingement, surface area, pore size, and thermal runaway, as summarized below in Examples 2-6 below. Additional Samples were tested with reinforcement materials as summarized in Example 7 below.

### Example 2. Thermal Conductivity

Sample 1 and Sample 2 were tested for thermal conductivity, as was the Comparative Sample (PyroThin® ATB1000) at both 1 mm and 2 mm thicknesses. A modified ASTM C518 protocol was used for testing thermal conductivity. Here, a Wenesco hot plate was used with a maximum temperature of 815° C. and a digital temperature controller. The cold plate was a 3.2 lb piece of aluminum metal that was exposed to ambient condition and allowed to equilibrate with the environment.

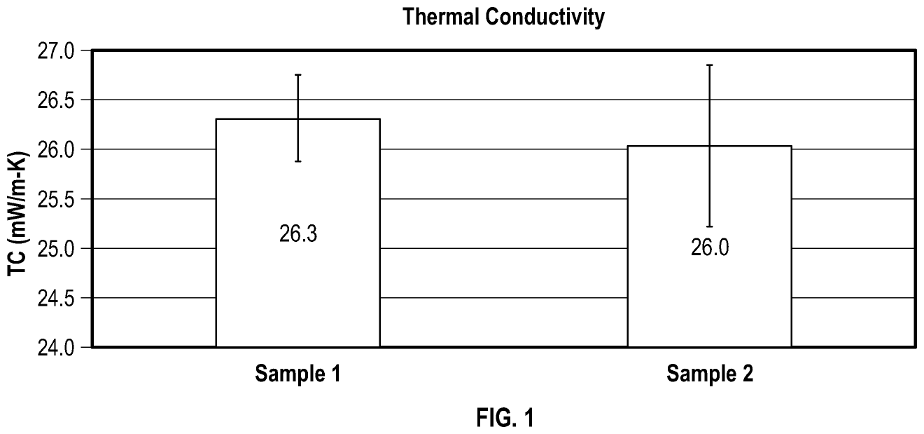

FIG. 1 depicts the thermal conductivity (mW/m-K) of both Sample 1 and Sample 2. Both Sample 1 and Sample 2 produced similar thermal conductivities, in the range of about 26.0 to about 26.5.

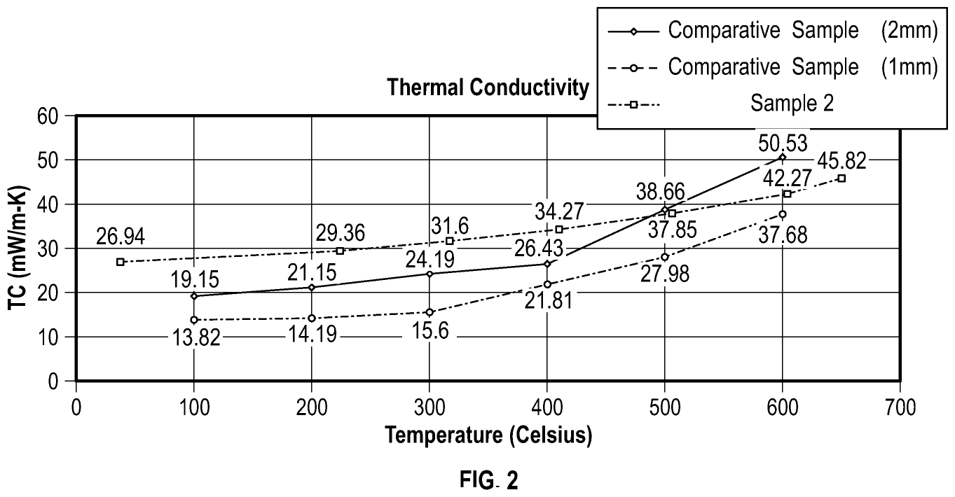

FIG. 2 depicts thermal conductivity at varying temperatures for both Sample 2 (combination sol) and Comparative Sample (PyroThin® ATB1000) at 1 mm and 2 mm thicknesses. Low temperature thermal conductivity of the Sample 1 and Sample 2 are higher than the Comparative Sample (shown at both 1 mm and 2 mm thicknesses). Thermal conductivity of Sample 1 and Sample 2 was also good at higher temperatures. Overall, both Samples performed well in thermal conductivity.

### Example 3. Density

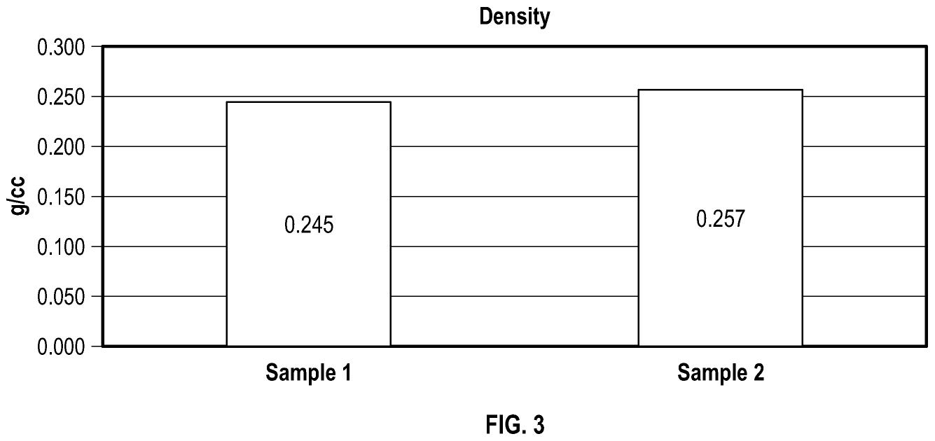

Sample 1 and Sample 2 were analyzed for density. The samples were measured for length, width, and height, and then weighed. The bulk density was calculated. Here, both Sample 1 and Sample 2 were produced on a glass fiber reinforcement structure for density testing. FIG. 3 depicts the density (g/cc) of both Sample 1 and Sample 2. Both Sample 1, using a core/shell production method, and Sample 2, using a combination sol production method, produced similar density results. Both Samples had densities in the range of about 0.24 to about 0.26 g/cc.

### Example 4. Flame Impingement

Sample 1 and Sample 2, each of having a thickness of about 2 mm, were tested for flame impingement with exposure to a 1100° C. flame for five minutes. Overall, each Sample survived 5 minutes of flame impingement, but showed no signs of melting and densification. Overall, both Samples performed well with the flame impingement testing.

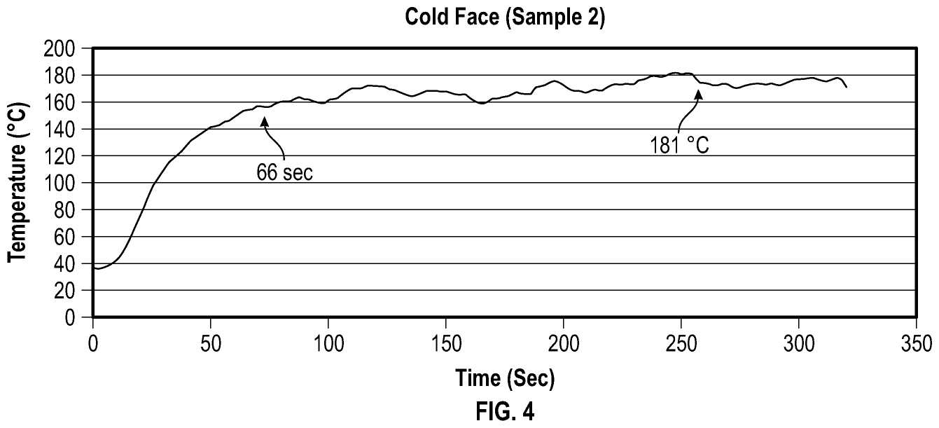

FIG. 4 depicts the cold face temperatures (° C.) of Sample 2 over those five minutes (shown in seconds on the x-axis). A steady cold face temperature was reached at approximately 66 seconds into the test, or just over a minute. The maximum cold face temperature was about 181° C.

### Example 5. Surface Area and Pore Size

Sample 1 and Sample 2 were analyzed for surface area, pore size, and pore volume using Brunauer-Emmett-Teller (BET) surface area analysis. Here, Sample 1 and Sample 2 were used in 2 mm thickness on a glass fiber reinforcement.

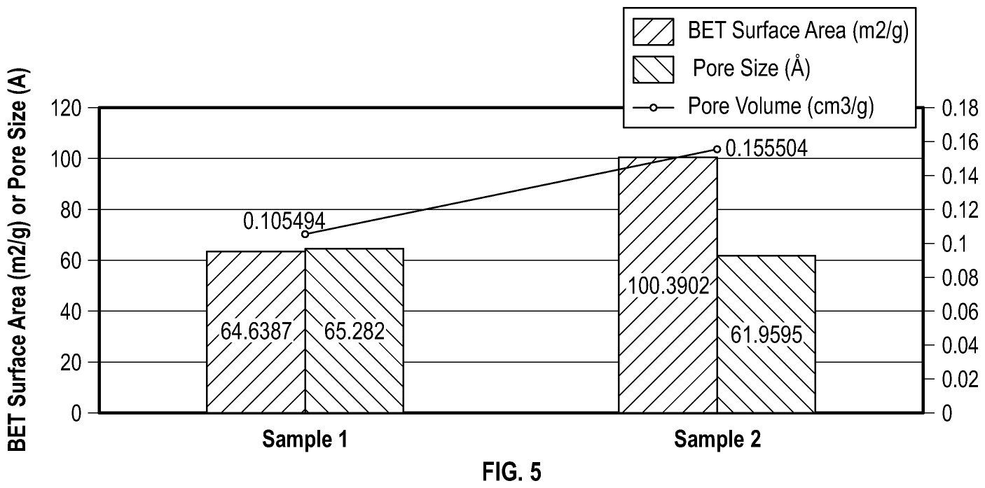

FIG. 5 depicts BET surface area (m²/g), pore size (Å), and pore volume (cm³/g) of both Sample 1 and Sample 2. Sample 1 maintains a surface area of about 64.6 m²/g, while Sample 2 has a larger surface area of about 100.4 m²/g. By comparison, many silica based aerogels, such as the Comparative Sample have a specific surface area of about 500-1200 m²/g on average. Sample 1 had a pore volume of about 0.11 cm³/g and an average pore size of about 65.2 Å, while Sample 2 has a pore volume of about 0.16 cm³/g, and an average pore size of about 62.0 Å.

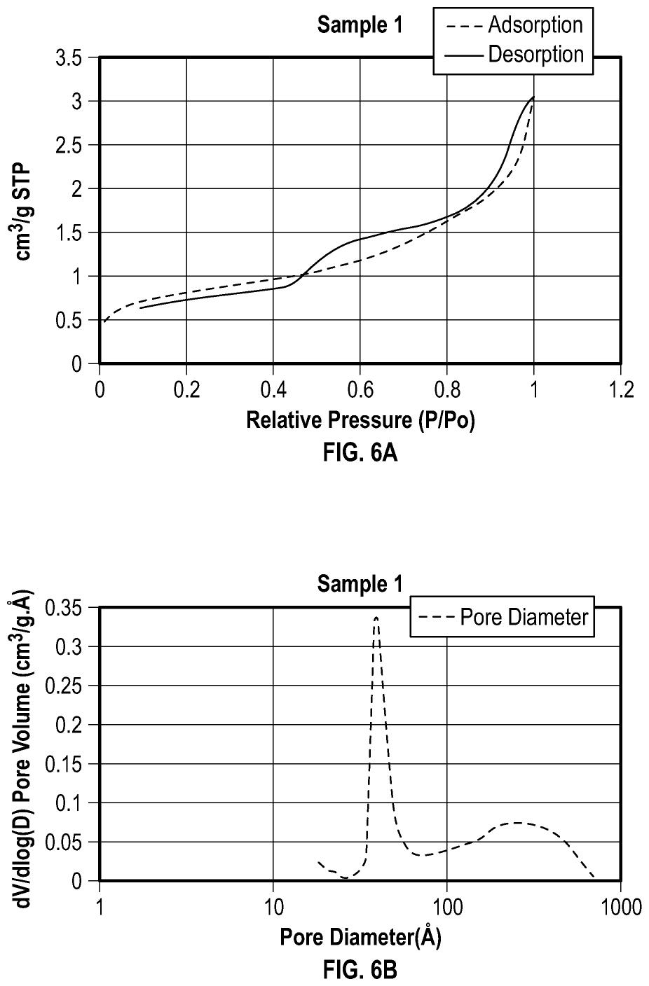

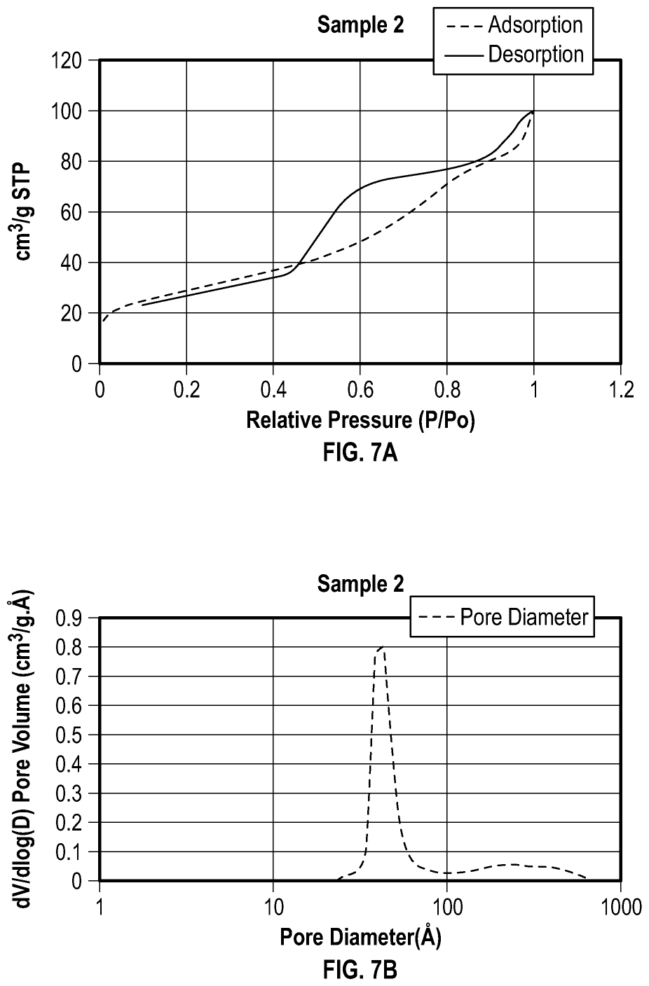

FIG. 6A and FIG. 6B depict additional data for Sample 1. Specifically, FIG. 6A depicts Sample 1 adsorption and desorption, while FIG. 6B depicts Sample 1 pore diameter (Å). FIG. 7A and FIG. 7B depict additional data for Sample 2. Specifically, FIG. 7A depicts Sample 2 adsorption and desorption, while FIG. 7B depicts Sample 2 pore diameter (Å).

### Example 6. Thermal Runaway

Sample 1 and Sample 2 were tested for thermal runaway with a simulated thermal runaway procedure. Both Sample 1 and Sample 2 were 2 mm thick on a glass reinforcement material for this simulation. In this simulation, a temperature of 1100° C. was applied to a hot face of the Samples for a period of 200 minutes.

Neither Sample 1 nor Sample 2 cracked during this simulation. By comparison, the Comparative Sample (ATB1000) performed worse. The Comparative Sample had extensive cracking. The Comparative Sample had signs of melting and densification. By comparison, both Sample 1 and Sample 2 did not show signs of melting or densification.

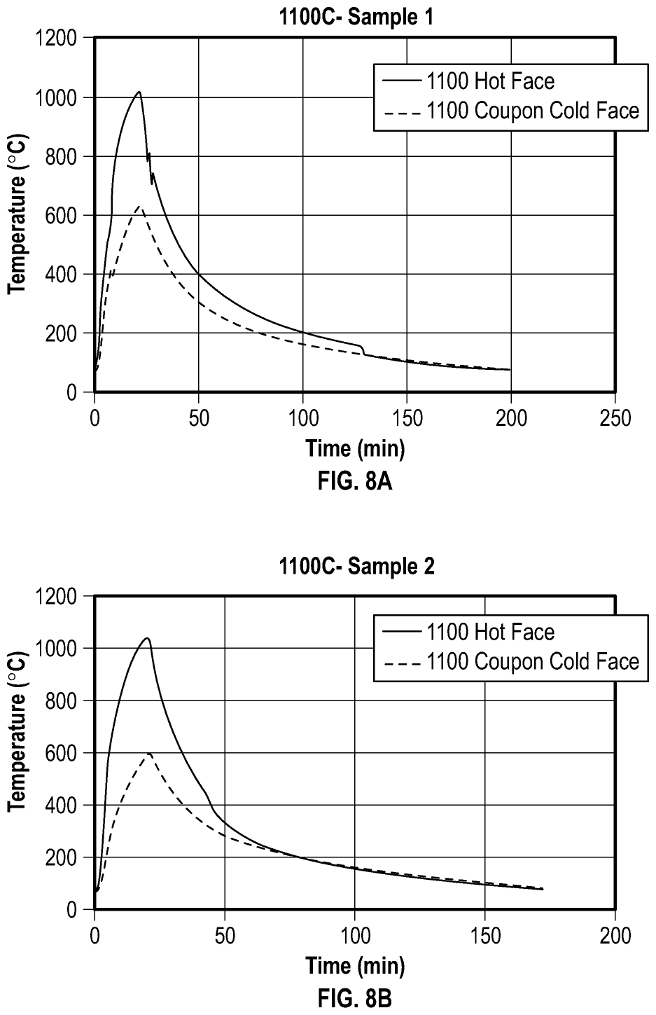

FIG. 8A and FIG. 8B depict the simulated thermal runaway temperatures (° C.) on both hot faces and cold faces of the Samples over time (minutes). FIG. 8A depicts Sample 1 (produced with core/shell methods) and FIG. 8B depicts Sample 2 (produced with combination sol methods). Both Sample 1 and Sample 2 had an average cold face temperature of about 600 to about 650° C. during the thermal runaway simulation.

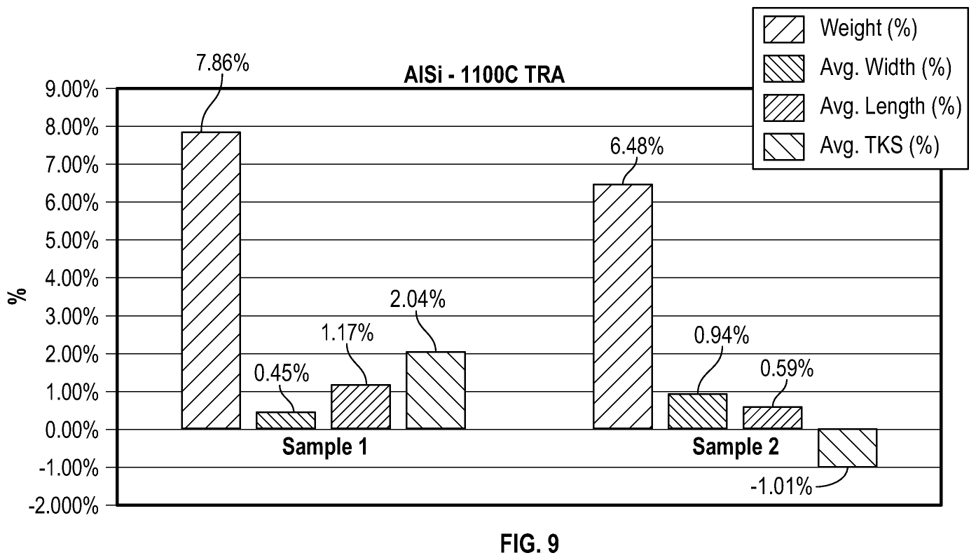

FIG. 9 depicts shrinkage (%) effects of the thermal runaway simulation on both Sample 1 and Sample 2. Here, the weight, average width, average length, and average thickness (TKS) were measured before and after the thermal runaway simulation. After the simulation, there was little shrinkage to the material overall in either Sample 1 or Sample 2. There was a small amount of weight loss in both Sample 1 and Sample 2, which could be attributed to water or sizing on the reinforcement material.

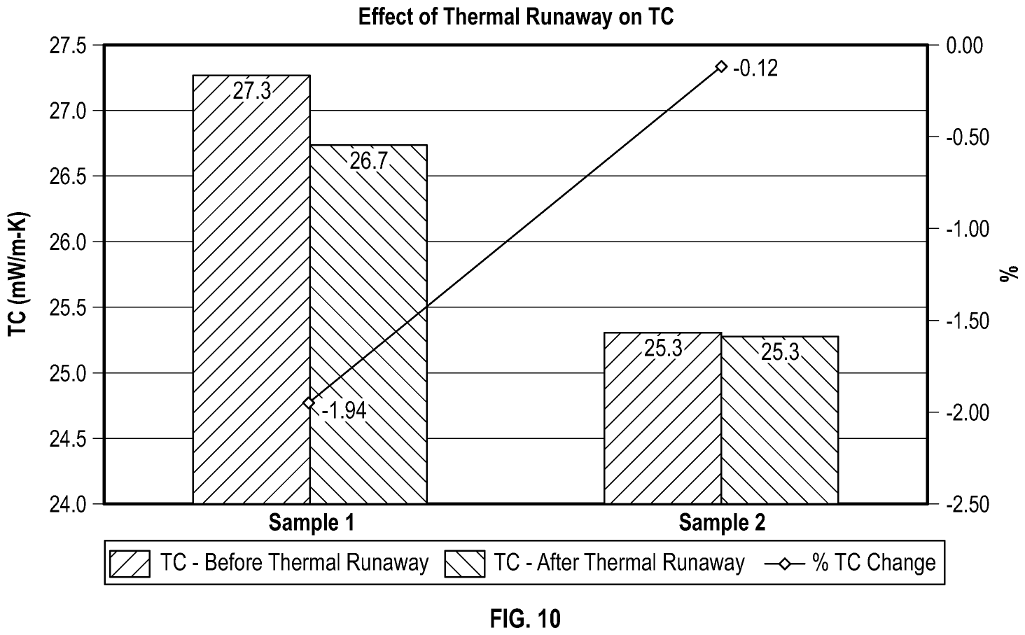

FIG. 10 depicts the effect of thermal runaway on thermal conductivity for both Sample 1 and Sample 2. The average thermal conductivity (mW/m-K) is shown for both before and after the thermal runaway simulation. After the thermal runaway simulation, there was little change in thermal conductivity for both Sample 1 and Sample 2.

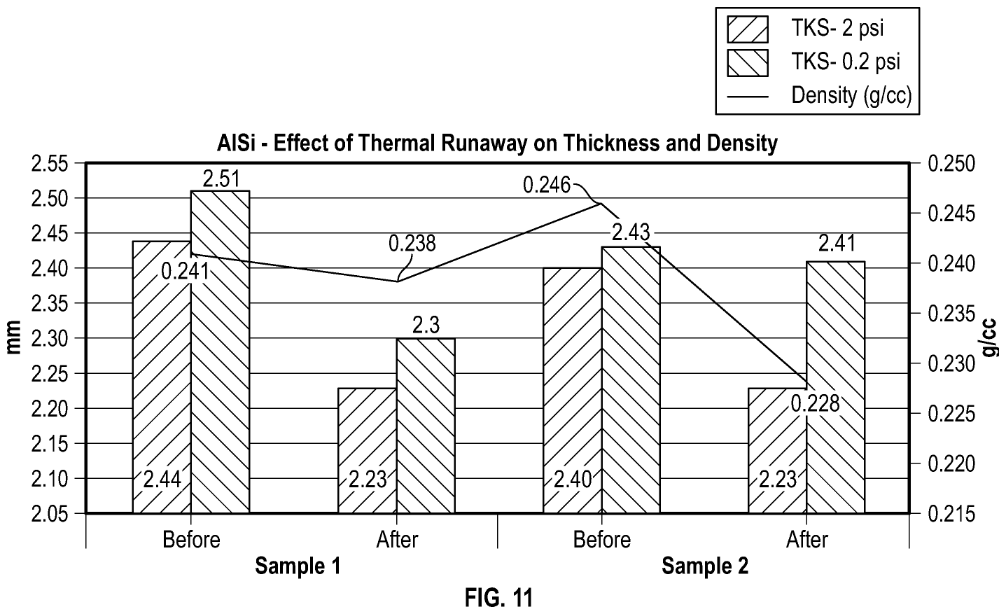

FIG. 11 depicts the effect of thermal runaway on thickness and density in both Sample 1 and Sample 2. Here, the thickness (TKS) (mm) both before and after the simulation are shown, in addition to the density (g/cc). There was a slight reduction in thickness of the Sample 1 and Sample 2, as well as a slight reduction in density.

Overall, both Sample 1 and Sample 2 held up well through and after the simulated thermal runaway.

### Example 7. Reinforcement Materials

Aluminosilicate aerogels samples were additionally produced with various reinforcement materials, and tested. While the Samples discussed above used only a glass reinforcement material, other were tested herein. These additional Samples are summarized below in Table 2:

TABLE 2
Samples with Reinforcement Materials.

| | | Production | Reinforcement |
|---|---|---|---|
| Sample ID | Description | Method | Material |
| Sample 1 | Aluminosilicate | Core/Shell | 1 mm Glass |
| | aerogel | | |
| Sample 1B | Aluminosilicate | Core/Shell | Melamine Foam |
| | aerogel | | |
| Sample 2 | Aluminosilicate | Combination Sol | 2 mm Glass |
| | aerogel | | |
| Sample 2B | Aluminosilicate | Combination Sol | Melamine Foam |
| | aerogel | | |

Casting Process. During production, these Samples used the core/shell or combination sol methodologies described above. However, the aluminum compound, boehmite, was added as the colloidal suspension was being cast onto a reinforcement material. The remaining gelation and processing steps were the sample as described with reference to Example 1 above.

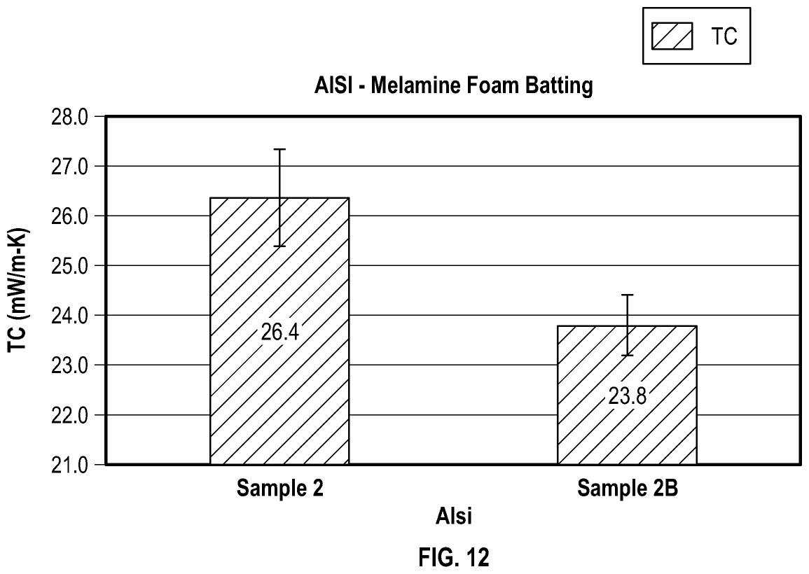

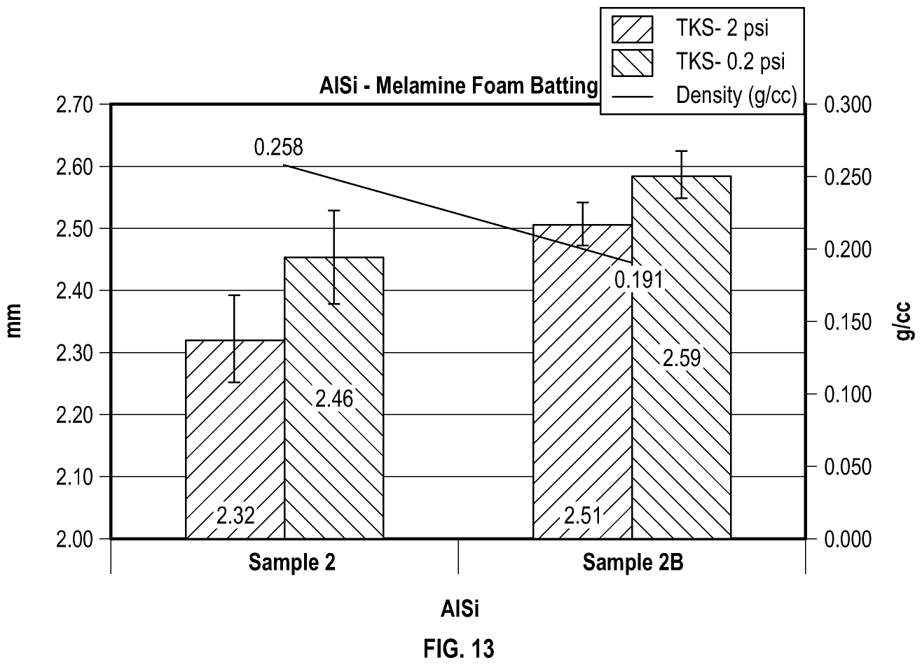

FIG. 12 and FIG. 13 compare Sample 2 and Sample 2B. Here, Sample 2 (using a glass reinforcement material), had a larger thermal conductivity than Sample 2B (using a melamine foam reinforcement material). The thickness of the Sample 2B was greater than the thickness of the Sample 2. Additionally, the density of the Sample 2B was lower than the Sample 2 density.

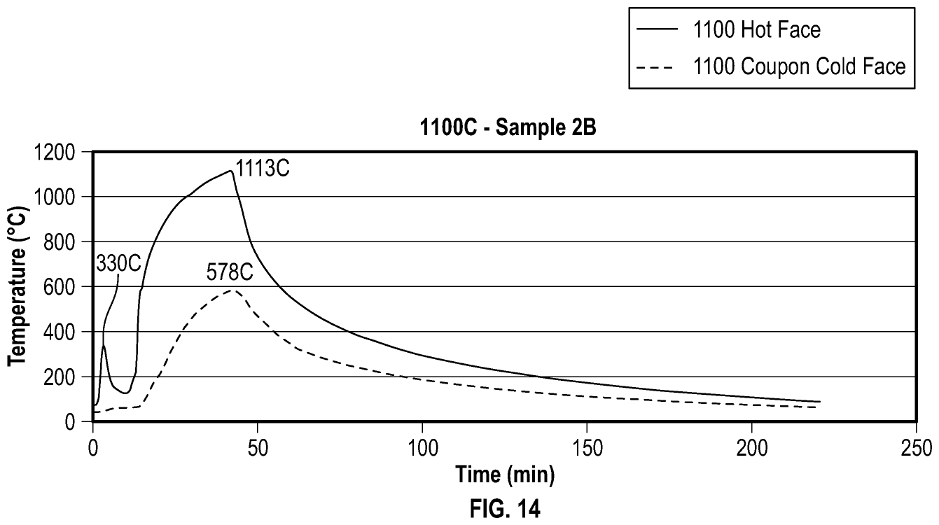

FIG. 14 depicts testing Sample 2 and Sample 2B for Simulated thermal runaway with exposure to a 1100° C. flame for over 200 minutes. Here, a small exothermal peak from melamine decomposition can be see right after the flame impingement has begun. However, the Sample 2B a cold face average temperature of about 600° C. Additionally, the Sample 2B with the melamine reinforcement material experienced some shrinking, and became brittle.

### Additional Examples

The following exemplary examples are provided, the numbering of which is not to be construed as designating levels of importance:

In some aspects, the techniques described herein relate to a method of making an aluminosilicate aerogel, the method including: receiving a silica precursor in solvent; hydrolyzing the silica precursor to produce colloidal silica; introducing an aluminum compound to the colloidal silica to produce a colloidal aluminosilicate suspension; converting the aluminosilicate suspension to an aluminosilicate gel composition; and forming the aluminosilicate aerogel by extracting fluid.

In some aspects, the techniques described herein relate to a method, wherein the silica precursor is fully hydrolyzed prior to introducing the aluminum compound.

In some aspects, the techniques described herein relate to a method, further including aging the aluminosilicate gel composition prior to forming the aluminosilicate aerogel.

In some aspects, the techniques described herein relate to a method, wherein aging the aluminosilicate gel composition includes heating the aluminosilicate gel composition at a temperature between 60° C. and 120° C.

In some aspects, the techniques described herein relate to a method, wherein aging the aluminosilicate gel composition is done for a time ranging from about 1 hour to about 24 hours.

In some aspects, the techniques described herein relate to a method, further including dispersing the colloidal aluminosilicate suspension on a reinforcement material prior to converting the aluminosilicate suspension to an aluminosilicate gel composition.

In some aspects, the techniques described herein relate to a method, wherein dispersing the colloidal silica on a reinforcement material and contemporaneously introducing the aluminum compound.

In some aspects, the techniques described herein relate to a method, wherein the reinforcement material is a fiber material or a foam material.

In some aspects, the techniques described herein relate to a method, wherein the silica precursor includes triethyl orthosilicate (TEOS), trimethyl orthosilicate (TMOS), methyl trimethoxysilane (MTMS), methyl triethoxysilane (MTES), dimethyl diethoxysilane (DMDES), trimethyl methoxysilane (TMS), dimethyl dimethoxysilane (DMS), trimethyl ethoxysilane, ethyl triethoxysilane (ETES), diethyl diethoxysilane, propyl trimethoxysilane, propyl triethoxysilane, phenyl trimethoxysilane, phenyl triethoxysilane (PhTES), hexamethyldisilazane and hexaethyldisilazane, or combinations thereof.

In some aspects, the techniques described herein relate to a method, wherein the aluminum compound includes boehmite, pseudoboehmite, alumina, aluminum trihydroxide, aluminum-alkoxides, aluminum hydro-carboxylic acid species, or combinations thereof.

In some aspects, the techniques described herein relate to a method, wherein hydrolyzing the silica precursor includes adding a sol initiator including hydrochloric acid, sulfuric acid, phosphoric acid, nitric acid, oxalic acid, acetic acid, or combinations thereof.

In some aspects, the techniques described herein relate to a method, wherein converting the aluminosilicate suspension to an aluminosilicate gel composition includes adding a gel initiator including a metal hydroxide base or an amine base.

In some aspects, the techniques described herein relate to a method, wherein forming the aluminosilicate aerogel includes extracting excess fluid using a supercritical extraction process.

In some aspects, the techniques described herein relate to an aluminosilicate aerogel made by the method.

In some aspects, the techniques described herein relate to a method of making an aluminosilicate aerogel, the method including: mixing a silica precursor in solvent to produce a precursor mixture; adding a sol initiator to the precursor mixture to produce a colloidal silica; adding an aluminum compound to the colloidal silica to form a colloidal aluminosilicate suspension; adding a gel initiator to the colloidal aluminosilicate suspension to convert the colloidal aluminosilicate suspension to an aluminosilicate gel composition; and extracting fluid from the aluminosilicate gel composition to form the aluminosilicate aerogel.

In some aspects, the techniques described herein relate to an aerogel including aluminosilicate including an aluminum-containing shell surrounding a silica core, wherein the aerogel includes a thermal conductivity of about 25 to about 30 mW/m-K.

In some aspects, the techniques described herein relate to an aluminosilicate aerogel, wherein the aluminosilicate aerogel has a surface area of about 60 to about 105 m²/g.

In some aspects, the techniques described herein relate to an aluminosilicate aerogel, wherein the aluminosilicate aerogel has an average pore size of about 60 to about 70 Å.

In some aspects, the techniques described herein relate to an aluminosilicate aerogel, wherein the aluminosilicate aerogel has a pore volume of about 0.10 to about 0.17 cm3/g.

In some aspects, the techniques described herein relate to an aluminosilicate aerogel, wherein the aluminosilicate aerogel has a density of about 0.200 to about 0.300 g/cc.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.”

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The terms and expressions that have been employed are used as terms of description and not of limitation, and there is no intention in the use of such terms and expressions of excluding any equivalents of the features shown and described or portions thereof, but it is recognized that various modifications are possible within the scope of the examples of the present disclosure. Thus, it should be understood that although the present disclosure has been specifically disclosed by specific examples and optional features, modification and variation of the concepts herein disclosed may be resorted to by those of ordinary skill in the art, and that such modifications and variations are considered to be within the scope of examples of the present disclosure.

1. A method of making an aluminosilicate aerogel, the method comprising:
hydrolyzing a silica precursor to produce colloidal silica;
introducing an aluminum compound to the colloidal silica to produce a colloidal aluminosilicate suspension, wherein the silica precursor is fully hydrolyzed prior to introducing the aluminum compound;
converting the colloidal aluminosilicate suspension to an aluminosilicate gel composition; and
aging the aluminosilicate gel composition;
forming the aluminosilicate aerogel by extracting a fluid.

2. (canceled)

3. The method of claim 1, wherein aging the aluminosilicate gel composition is done prior to forming the aluminosilicate aerogel.

4. The method of claim 1, wherein aging the aluminosilicate gel composition comprises heating the aluminosilicate gel composition at a temperature between 60° C. and 120° C.

5. The method of claim 1, wherein aging the aluminosilicate gel composition is done for a time ranging from about 1 hour to about 24 hours.

6. The method of claim 1, further comprising dispersing the colloidal aluminosilicate suspension on a reinforcement material prior to converting the colloidal aluminosilicate suspension to an aluminosilicate gel composition.

7. The method of claim 1, wherein dispersing the colloidal silica on a reinforcement material and contemporaneously introducing the aluminum compound.

8. The method of claim 7, wherein the reinforcement material is a fiber material or a foam material.

9. The method of claim 1, wherein the silica precursor comprises triethyl orthosilicate (TEOS), trimethyl orthosilicate (TMOS), methyl trimethoxysilane (MTMS), methyl triethoxysilane (MTES), dimethyl diethoxysilane (DMDES), trimethyl methoxysilane (TMS), dimethyl dimethoxysilane (DMS), trimethyl ethoxysilane, ethyl triethoxysilane (ETES), diethyl diethoxysilane, propyl trimethoxysilane, propyl triethoxysilane, phenyl trimethoxysilane, phenyl triethoxysilane (PhTES), hexamethyldisilazane and hexaethyldisilazane, or combinations thereof.

10. The method of claim 1, wherein the aluminum compound comprises boehmite, pseudoboehmite, alumina, aluminum trihydroxide, aluminum-alkoxides, aluminum hydro-carboxylic acid species, or combinations thereof.

11. The method of claim 1, wherein hydrolyzing the silica precursor comprises adding a sol initiator comprising hydrochloric acid, sulfuric acid, phosphoric acid, nitric acid, oxalic acid, acetic acid, or combinations thereof.

12. The method of claim 1, wherein converting the colloidal aluminosilicate suspension to an aluminosilicate gel composition comprises adding a gel initiator comprising a metal hydroxide base or an amine base.

13. The method of claim 1, wherein forming the aluminosilicate aerogel comprises extracting excess fluid using a supercritical extraction process.

14. An aluminosilicate aerogel made by the method of claim 1.

15. (canceled)

16. An aerogel comprising aluminosilicate comprising a silica shell surrounding an aluminum containing core, wherein the aerogel comprises a thermal conductivity of about 20 to about 30 mW/m-K.

17. The aluminosilicate aerogel of claim 16, wherein the aluminosilicate aerogel has a surface area of about 60 to about 105 m²/g.

18. The aluminosilicate aerogel of claim 16, wherein the aluminosilicate aerogel has an average pore size of about 60 to about 70 Å.

19. The aluminosilicate aerogel of claim 16, wherein the aluminosilicate aerogel has a pore volume of about 0.10 to about 0.17 cm³/g.

20. The aluminosilicate aerogel of claim 16, wherein the aluminosilicate aerogel has a density of about 0.200 to about 0.300 g/cc.
